(19) United States
(12) Patent Application Publication
(10) Pub. No.: US 2023/0045332 A1
(43) Pub. Date: Feb. 9, 2023

(54) Fruit harvesting machine

(71) Applicant: Victor Embarba Pinilla, Zaragoza (ES)

(72) Inventor: Victor Embarba Pinilla, Zaragoza (ES)

(21) Appl. No.: 17/789,239

(22) PCT Filed: Dec. 23, 2020
(86) PCT No.: PCT/ES2020/070816

§ 371 Date: Jun. 27, 2022

(30) Foreign Application Priority Data
Dec. 27, 2019 (ES) U 201932130

(51) Int. Cl. A01D 46/26; A23N 5/08

(52) U.S. Cl. CPC A01D 46/26; A23N 5/08; A01D 2046/262; A01D 46/253

(57) ABSTRACT

Fruit harvesting machine which, having a folding canvas frame “umbrella type” coupled to a structure with wheels on which it is moved to place it adjusted to the trunk of a tree and collect the fruit on said canvas making it fall by gravity, is distinguished by the fact that said structure is constituted by a trolley which, being able to be of manual or motorized pushing displacement, comprises, at least, a peeler, includes, at least, an automatic peeler arranged between two tanks, an upstream receiving tank where the fruit collected on the tarpaulins falls and a downstream storage tank where the peeled fruit is taken, making the machine particularly suitable for the harvesting of nuts such as almonds or pistachios that are marketed peeled.

### CROSS-REFERENCE TO RELATED APPLICATIONS

This application is a National Stage entry from PCT/ES2020/070816

### STATEMENT REGARDING FEDERALLY SPONSORED RESEARCH OR DEVELOPMENT

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT INCORPORATION-BY-REFERENCE OF MATERIAL SUBMITTED ON A COMPACT DISC

Not Applicable

### BACKGROUND OF THE INVENTION TECHNICAL FIELD

The field of application of the present invention is framed within the sector of the industry dedicated to the manufacture of agricultural machinery, focusing particularly on the field of fruit harvesting apparatus and machines.

### Description of Related Art

Fruit harvesting machines, such as almond or olive harvesters, are widely known on the market. They are made up of a frame of folding rods, like an umbrella, with canvas or net cloths which, coupled to a structure with wheels or to a tractor, are placed on the ground, and are used for the harvesting of fruit.

The umbrellas are made up of a folding umbrella-like frame with canvas or net cloths which, attached to a wheeled structure or tractor, are placed under the tree trunk to collect the fruit that falls when vibration is applied.

These devices, however, in addition to their large dimensions (in extended position they usually have a diameter of up to 680 cm), as they are designed only for the harvesting of tree fruits where the space between trees is usually very wide, have the disadvantage of being limited to serve only for that function of collection, with which, if, for example, the fruit is to be peeled, as is the case with almonds or pistachios, which are marketed with and without shell, the farmer must carry out a second operation with a separate peeling machine to obtain the peeled fruit, with the consequent transfer of the fruit from the picker to the peeler and the corresponding tanks for this purpose.

The aim of the present invention is, therefore, to provide the market with a new type of picker which is also a peeler and allows a much more versatile use and can be used both for picking the fruit and, at the same time, for peeling the same, avoiding the performance of two separate operations and, with this, an important saving of time, but also allowing it to be used in a more versatile way in the sense of being able to be used without the peeler and to be used for harvesting all types of fruits and berries, even in irrigated lands, where the spaces between trees are much narrower, for which it can be used without having to be coupled to a tractor and the machine itself is motorized and equipped with large capacity tanks to transport the harvested fruit.

On the other hand, and as a reference to the current state of the art, it should be pointed out that, although as has been said, other types of umbrella-type harvesting apparatus are known on the market, at least by the applicant, it is not known of the existence of any that present technical, structural and constitutive characteristics equal or similar to those presented by the machine claimed herein.

### BRIEF SUMMARY OF THE INVENTION

The invention, as expressed in the wording of the present descriptive memory, refers to a fruit harvesting machine which brings, to the function for which it is intended, advantages and characteristics, described in detail below, which represent an improvement of the present state of the art.

More specifically, the object of the invention is centered on a fruit picking machine which, being one of those made up of a folding “umbrella-type” canvas frame coupled to a wheeled structure on which it is moved to place it under the trees and pick the fruit, is distinguished in that said structure, among other characteristics, presents the particularity of being configured as a manually or motor-driven trolley which, at least includes an automatic peeler and two reception and storage tanks that make the machine particularly suitable for the harvesting of nuts such as almonds or pistachios, and where said peeler is preferably removable so that the same machine can also be used for the harvesting of other fruits that do not need to be peeled, such as olives or other fruits, thus increasing the harvesting capacity.

### BRIEF DESCRIPTION OF THE DRAWINGS

In order to complement the description that is being made and with the purpose of helping to a better understanding of the characteristics of the invention, the present descriptive memory is accompanied, as an integral part of the same, by a set of drawings in which the following has been represented with illustrative and not limiting character:

FIG. 1.—Shows a schematic perspective view of a first example of realization of the fruit harvesting machine object of the invention, specifically an example of its variant of displacement by manual push, represented in folded position, appreciating its general external configuration and the main parts and elements it comprises.

FIG. 2.—Shows a schematic perspective view of a second example of an embodiment of the harvesting machine of the invention, in this case an example of its variant with motorized displacement represented with the cloth frame unfolded, showing its general configuration and the main parts and elements it comprises.

FIG. 3.—Shows a schematic perspective view of a portion of the machine, according to the example shown in FIG. 2, specifically of the peeler with emptying auger and the storage tank

FIG. 4.—Shows a schematic view in top plan of the example of the machine, according to the invention, shown in FIG. 2, in this case represented with the folded cloth frame.

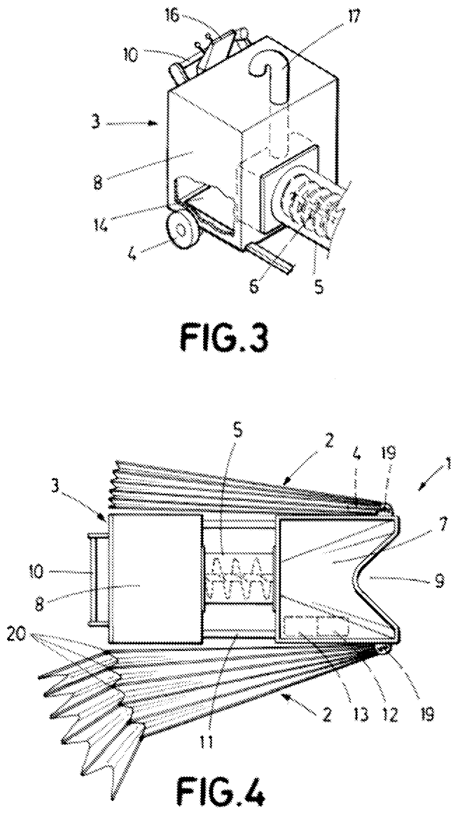

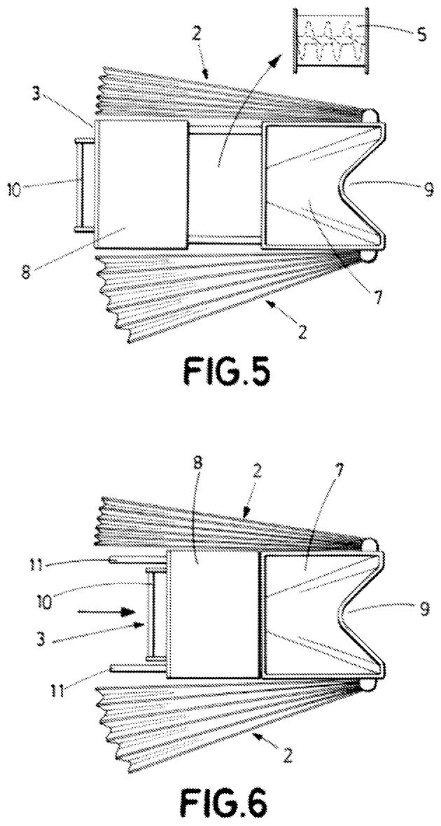

And FIGS. 5 and 6.—Show a schematic top plan view of the machine, according to the example of FIGS. 3 and 4, represented in the respective phases of extraction of the peeler and displacement of the tank.

### DETAILED DESCRIPTION OF THE INVENTION

The fruit harvesting machine proposed by the invention makes it possible to satisfactorily attain the above-mentioned objectives, being the details

The invention is based on the invention, the details which make it possible and which distinguish it are conveniently set forth in the final claims accompanying the present description.

The machine that the invention proposes, as mentioned above, is a fruit harvesting machine which, having a frame of folding “umbrella-type” tarpaulins coupled to a structure with wheels on which it is moved to place it adjusted to the trunk of a tree and collect the fruit on said tarpaulins making it fall by gravity, is distinguished by the fact that said structure is constituted by a trolley which, The machine is particularly suitable for the harvesting of nuts such as almonds or pistachios that are marketed peeled, and is therefore particularly suitable for the harvesting of nuts such as almonds or pistachios that are marketed peeled.

Moreover, in a preferred embodiment, said peeler is removable and at least one of the tanks can be moved to create a single tank with greater collection capacity, allowing the same machine to be used also for the harvesting of other fruits that do not have to be peeled, such as olives or other fruits.

For all this, preferably, the trolley structure has two or four wheels, depending on whether it is manual or motorized, and a system of guides on which the rear storage tank slides from the rear to occupy the central space of the removable peeler, once removed, and is attached to the front receiving tank, being the respective openings of both tanks located in coincidence to fit together once both tanks are attached.

In addition, the front face of the front collection tank has an indentation that favors the adjustment of the machine to the trunk of the tree.

In any case, the materials of the guide structure, the tanks and the peeler are very resistant to shocks and humidity.

On the other hand, preferably, the folding of the tarpaulin frame is automated by means of a small electric motor provided for this purpose.

From the described general configuration, the machine of the invention, in a first variant of realization in which the carriage

In a first variant of realization in which the trolley is moved by means of a manual push drive, preferably, it incorporates a peeler driven by a gasoline engine with a power of 2.3 hp, and, preferably, the storage tank is emptied through a flap provided for the purpose in its lower part.

Furthermore, in this option, preferably, the dimensions of the cart, which only has two front wheels and a rear handlebar, are smaller, approximately 170 cm long, 90 cm wide and 60 cm high, where the front tank is about 80 cm long and the rear storage tank has a capacity for approximately 35 to 40 kg of fruits such as almonds once peeled, which is the weight that a sack usually has, or for about 75 kg of other fruits such as olives.

All this makes this variant of the machine very agile to be able to put it between banks, edges, etc. allowing a perfect adjustment to the tree.

And, in a second variant of realization of the machine, where the cart is moved by motorized drive, the structure of the same has four wheels and is of greater dimension, counting approximately 180 cm long, 110 wide and 75 high, where the front tank is also about 80 cm long but the rear storage tank has a capacity for up to 100 kg of peeled fruit.

Preferably, in this variant, the trolley incorporates two electric motors, for its displacement and for an emptying auger of the peeler, which are powered by lithium batteries, which, optionally, are replaced or combined with an electric power supply through solar panels, preferably attached to the sides of the trolley tanks. In this variant, the peeler also has a gasoline engine but with a higher power, between 2, 5 to 7 hp.

Preferably, for the operation of the machine, a control panel is provided on the rear side of the machine by means of a lever or “joystick” with two forward/backward positions.

### DESCRIPTION OF THE PREFERRED EMBODIMENT

In view of the aforementioned figures, and in accordance with the numbering adopted, it is possible to observe in them an example of a non-preferred embodiment of the invention.

In view of the aforementioned figures, and in accordance with the numbering adopted, an example of a non-limiting embodiment of the fruit harvesting machine of the invention can be seen in them, which comprises the parts and elements indicated and described in detail below.

Thus, as can be seen in said figures, the machine (1) in question is essentially made up of a folding “umbrella-type” canvas frame (2) coupled to a structure (3) with wheels (4) which makes it possible to move it in order to place it adjusted to the trunk of a tree and collect the fruit which, by shaking or vibrating, is made to fall on the canvas frame (2) arranged in an unfolded position around the trunk, with the particularity that the aforementioned structure in which the folding canvas frame (2) is incorporated is a trolley (3) comprising at least one automatic fruit peeler (5) which, optionally, is provided with an emptying auger (6) and is arranged between a reception tank (7), into which the fruit collected by the canvas frame (2) falls, and a storage tank (8), into which the fruit is conveyed after passing through the peeler (5).

Preferably, the peeler (5) is a removable module and, preferably, at least one of the tanks (8) can be moved to be coupled to the other (7) to create a single tank of greater capacity.

Preferably, the structure of the trolley (3) has an elongated configuration with the receiving tank (7) in its front part, presenting an indentation (9) to favor its adjustment to the trunk of the tree, the peeler (5) in the center and the storage tank (8) in its rear part where it includes a handle (10) for handling, There are guides (11) along which the storage tank (8) slides from the rear to occupy the central space of the peeler (5) when it is removed and is attached to the receiving tank (7).

FIGS. 4, 5 and 6 show such transformation.

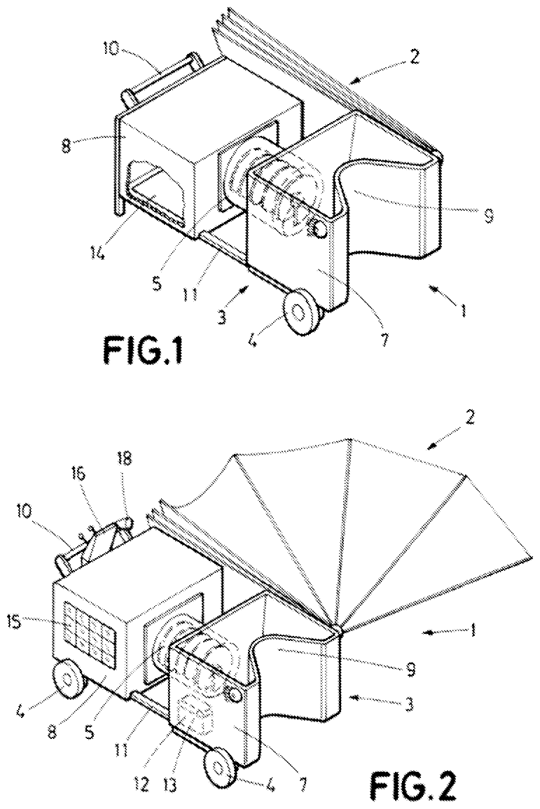

In a variant of realization, as shown in FIG. 1, the trolley (3) is of manual type and moves by push driven from the handlebar (10) lifting it by its rear part to make it roll on only two front wheels (4).

And, in a second variant of realization as shown in FIG. 3, the trolley (3) is motorized and moves on four wheels (4) by means of a drive of a main electric motor (12) powered by the main electric motor (12) powered by a lithium battery (13).

Preferably, the variant in which the trolley (3) is manual, said trolley (3) has small dimensions, of about 170 cm in length and about 170 cm in width.

The dimensions are small, about 170 cm long by 90 cm wide and 60 cm high, and the capacity of the storage tank (8) is about 40 kg, which, also preferably, is emptied through a trap door (14) provided for this purpose in its lower part, and also preferably, the peeling machine (5) is driven by a 2.3 hp gasoline engine (not shown).

And, on the other hand, in the variant of motorized cart (3), preferably, the cart (3) is larger, with 180 cm long, 110 cm wide and 75 cm high, and storage tank (8) with capacity for up to 100 kg of peeled fruit.

In this variant, the preferred form also incorporates an electric motor (not shown) for the emptying auger (6) of the peeler (5) powered by the same or another lithium battery (13), and in which the peeler (5) also has a gasoline engine, in this case of greater power, between 2, 5 to 7 hp. FIG. 3 shows the aforementioned emptying auger (6) in the peeler (5), as well as the storage tank (8) to which the peeled fruit is conveyed once it has been peeled, where the peel is expelled through an extraction tube (17). In this case, the emptying flap (4) is also included.

Optionally, the lithium batteries (13) are replaced or combined with one or more solar panels (15).

Preferably, for the operation of the machine in the motorized trolley variant (3), this incorporates a control panel (16) by means of a joystick type lever with two forward/reverse positions located next to the handlebars (10).

In any case, the folding and unfolding of the canvas frame (2) on both sides of the trolley (3) is automated by means of a small motor (not shown). It should be noted that, although in FIGS. 1 and 3 said tarpaulin frame (2) has been shown covering only one side of the trolley (3) in order to provide a better visualization of the configuration and characteristics of the trolley (3) and its parts, it is to be understood that said tarpaulin frame (2) covers both sides of said carriage (3).

Having sufficiently described the nature of the present invention, as well as the manner of putting it into practice, it is not considered necessary to make its explanation more extensive so that It should be noted that, within its essential nature, it may be put into practice in other forms of realization which differ in detail from the one indicated by way of example, and to which the protection claimed will also apply provided that its fundamental principle is not altered, changed or modified.

1.—A fruit collecting machine a folding consisting of an “umbrella-type” canvas frame (2) coupled to a structure (3) with wheels (4) which enables it to be moved to be positioned close to any trunk of a tree and to collect the fruit which, by shaking or vibrating, is made to fall on the canvas frame (2) arranged in an unfolded position around the trunk, comprising
a folding canvas frame (2) that is incorporated as a trolley (3)
at least one automatic peeler (5) arranged between a reception tank (7), where the fruit collected by the canvas frame (2) falls, and
a storage tank (8), where the fruit is conveyed after passing through the peeler (5).

2.—The machine according to claim 1, wherein the automatic peeler (5) is a removable module on itself.

3.—The machine according to claim 1, wherein the storage tanks (8) can be moved to be coupled to the reception tank (7) and create a single tank of greater capacity.

4.—The machine according to claim 1, wherein the structure of the trolley (3) has an elongated configuration with the receiving tank (7) in its front part, presenting an indentation (9) to favor its adjustment to the trunk of the tree, the peeler (5) in the center and the storage tank (8) in its rear part where it includes a handlebar (10) for handling, with guides (11) along which the storage tank (8) slides from the rear to occupy the central space of the peeler (5) when it is removed and is attached to the receiving tank (7).

5.—The machine according to claim 1, wherein MACHINE, according to any of the claims 1 to 4, characterized in that the cart (3) has two front wheels (4) and moves by pushing it from the handlebar (10).

6.—The machine according to claim 1, wherein the structure (3) moves on four wheels (4) by means of an electric motor (12).

7.—The machine according to claim 1, wherein the motor (12) of the cart (3) is powered by a lithium battery (13).

8.—The machine according to claim 1, wherein the motorized cart (3) incorporates a control panel (15) for its operation by means of a “joystick” type lever with two forward/backward positions.

9.—The machine according to claim 1, wherein the storage tank (8) of the cart (3) is emptied through a trap door (14).

10.—The machine according to claim 1, wherein the peeler (5) is driven by a gasoline engine.

11.—The machine according to claim 1, wherein the peeler (5) has an emptying auger (6) driven by an electric motor powered by a lithium battery (13).

12.—The machine according to claim 1, wherein solar panels (15) are included to the machine for power supply.

13.—The machine according to claim 1, wherein the canvas frame (2) includes an electric motor for its automatic folding and unfolding.
